(19) United States
(12) Patent Application Publication
(10) Pub. No.: US 2006/0064723 A1
(43) Pub. Date: Mar. 23, 2006

(54) Method for an instant pop-up interface for a set-top box

(76) Inventor: Thomas Poslinski, Elma, NY (US)

Correspondence Address: WAGNER, MURABITO & HAO, LLP, TWO NORTH MARKET STREET, THIRD FLOOR, SAN JOSE, CA, 95113, US

(21) Appl. No.: 10/946,641

(22) Filed: Sep. 20, 2004

(51) Int. Cl. H04N 5/445

(52) U.S. Cl. 725/52

(57) ABSTRACT

Embodiments of the present invention recite a method for an instant pop-up interface for a set-top box. In one embodiment, a first instance of media content is played or received via a set-top box. An indication is received to display a user interface of the set-top box. In response, the user interface is generated on the display without interrupting the displaying of the first instance of media content. In one embodiment, the user interface comprises a pop-up window displayed with a scrollable list therein. The list is of recorded or otherwise selectable content of the set-top box.

### FIELD OF THE INVENTION

The present invention relates to the field of digital recording. More specifically, embodiments of the present invention are directed to a method for providing a selection interface for a set-top box.

### BACKGROUND OF THE INVENTION

A digital set-top box is a device that enables a television to become a user interface to the Internet and also enables a television to receive and decode digital television (DTV) broadcasts. A digital set-top box may also be used by television viewers who wish to use their current analog television sets to receive digital broadcasts. Digital set-top boxes are often referred to as digital video recorders (DVRs) and personal video recorders (PVRs). DVRs are devices that can record media content (e.g., television programming) using digital media (e.g., a hard disk or memory) rather than video tape.

A PVR performs the same functions as a DVR but has more features that allow the PVR to function as a multimedia center. Additional features commonly provided by PVRs include the ability to play games, watch picture slide shows, listen to music as well as being able to program the PVR to record media content based upon user defined parameters. For example, a user can provide the name of a television series and the PVR will record and store episodes of that series that are available. Other user defined parameters include the name of an actor, a director, or even a keyword.

A typical digital set-top box contains one or more digital processors for running its operating system and for parsing the MPEG transport stream of a digital broadcast. A digital set-top box may also include RAM, an MPEG decoder chip, and additional chips for audio decoding and processing. More sophisticated digital set-top boxes may also contain a hard drive for storing recorded television broadcasts, for downloaded software, and for other applications provided by a DTV service provider. Some digital set-top boxes may also include a writeable digital versatile disk drive (e.g., a DVD R/W drive) to facilitate creating copies of broadcast content.

In a standard PVR/DVR set-top box implementation, a user accesses recorded media content through a full screen user interface screen. Typically, while the user is using the user interface screen, playback of audio and/or video media content is suspended or otherwise interrupted. The user then navigates a plurality of user interface screens. After the user has made a selection, playback of the media content can resume. Additionally, some users find navigating the plurality of user interface screens to be cumbersome and time consuming.

### SUMMARY OF THE INVENTION

It would be advantageous to provide a user interface which does not interfere with the playback of currently accessed media content. While meeting the above stated need, it would be desirable to provide a user interface which is more easily navigated than conventional implementations.

Embodiments of the present invention recite a method for an instant pop-up interface for a set-top box. In one embodiment, a first instance of media content is accessed via a set-top box. An indication is received to display a user interface of the set-top box. In response, the user interface is displayed without interrupting the accessing or playback of the first instance of media content. In embodiments of the present invention, the user interface can list possible content that is viewable. The interface also facilitates selection of one or more media content instances.

For example, a user is allowed to watch a television program which is accessed via a set-top box coupled with a television. The user decides to watch a movie which was previously recorded and stored on the set-top box. However, the user does not want to interrupt the television program to access the set-top box interface in order to select a movie. Using the present invention, the user can indicate, for example with a wireless remote controller for the set-top box, that they want the user interface to be displayed. In response, the set-top box creates a list of media content which is accessible to the user and causes a pop-up window to be displayed in a sub-region of the television screen. In embodiments of the present invention, the pop-up window comprises a user interface which displays the list of media content accessible via the set-top box.

In the present invention, while the user interface is being displayed, the television program being watched by the user continues to be displayed while the user interface is displayed in conjunction with the program. In embodiments of the present invention, the user interface comprises a selection mechanism or pop-up window which allows a user to scroll through the list of titles and to identify a particular title which the user would like to view. In embodiments of the present invention, the pop-up window may be displayed in one corner of the screen. The user can make a selection indication and the television program currently being watched is terminated and the selected media content is accessed. In embodiments of the present invention, display of the user interface is then automatically terminated.

In one embodiment, a controller device having a rocker or spinner knob can be used to invoke display of the pop-up window and also effectuate scrolling through the program listing. Only a few programs of the list are displayable at any given time in the window. The knob can also function as a push button for selecting a highlighted program.

Embodiments of the present invention are advantageous over prior implementations because the user can continue watching programming while the user interface is displayed. Additionally, embodiments of the present invention provide a simpler user interface which facilitates faster selection of the media content.

### BRIEF DESCRIPTION OF THE DRAWINGS

The accompanying drawings, which are incorporated in and form a part of this specification, illustrate embodiments of the present invention and, together with the description, serve to explain the principles of the invention. Unless specifically noted, the drawings referred to in this description should be understood as not being drawn to scale.

FIG. 1 is a block diagram of an exemplary network for distributing media content in accordance with embodiments of the present invention.

FIG. 2 is a block diagram of an exemplary set-top box used for user secure access to user content recordings in accordance with embodiments of the present invention.

FIG. 3 is a block diagram, showing in greater detail, components of an exemplary set-top box used for user secure access to user content recordings in accordance with embodiments of the present invention.

FIG. 4 is a flowchart of a method for user secure access to user content recordings in accordance with embodiments of the present invention.

FIG. 5 shows a plurality of exemplary screens displayed in accordance with embodiments of the present invention.

FIG. 6 shows an exemplary controller used in accordance with embodiments of the present invention.

FIG. 7 is a flowchart of a method for selecting media content in accordance with embodiments of the present invention.

FIG. 8 is a flow chart of a method for accessing media content in accordance with embodiments of the present invention.

### DETAILED DESCRIPTION OF EMBODIMENTS OF THE PRESENT INVENTION

Reference will now be made in detail to embodiments of the present invention, examples of which are illustrated in the accompanying drawings. While the present invention will be described in conjunction with the following embodiments, it will be understood that they are not intended to limit the present invention to these embodiments alone. On the contrary, the present invention is intended to cover alternatives, modifications, and equivalents which may be included within the spirit and scope of the present invention as defined by the appended claims. Furthermore, in the following detailed description of the present invention, numerous specific details are set forth in order to provide a thorough understanding of the present invention. However, embodiments of the present invention may be practiced without these specific details. In other instances, well-known methods, procedures, components, and circuits have not been described in detail so as not to unnecessarily obscure aspects of the present invention.

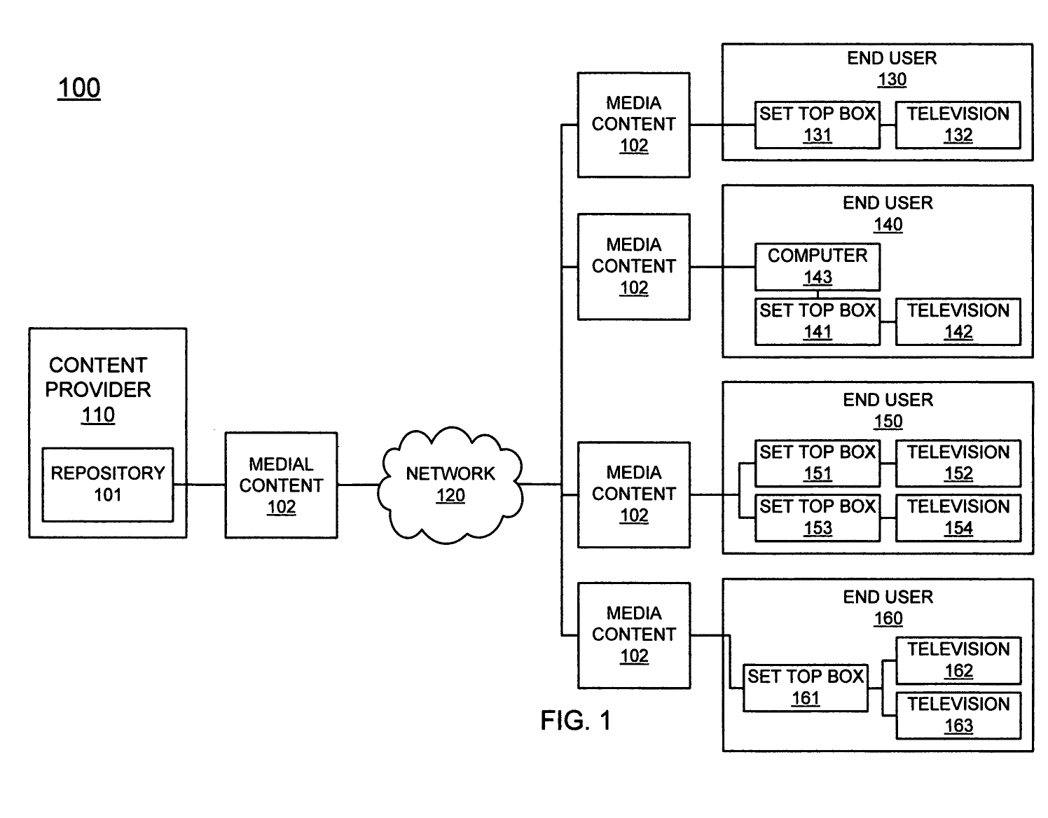

FIG. 1 is a block diagram of an exemplary network for distributing media content in accordance with embodiments of the present invention. In FIG. 1, a content provider 110 distributes media content 102 to a plurality of users (e.g., end users 130, 140, 150, and 160) via network 120. In embodiments of the present invention, media content 102 may comprise any information, e.g., video content (e.g., a television broadcast, a movie, a game, a pay-per-view event, etc.), audio content (e.g., music, a speech, a theatrical performance, etc), an image, or text. Additionally, network 120 may comprise a broadcast network, the Internet, a telephone network, or the like. In embodiments of the present invention, the media content 102 is distributed as a digitally encoded signal. The signal is received as an input into a set top box (e.g., set top boxes 131, 141, 151, and 161) by each of the end user's, converted into an analog signal, and output, for example, to the end user's television (e.g., televisions 132, 142, 152, 154, 162, and 163). In another embodiment, media content 102 may be distributed as an analog signal.

There are a variety of configurations which may be used by end users to couple a digital set-top box with content provider 110 in embodiments of the present invention. For example, end user 130 has coupled television 132 with network 120 via digital set-top box 131. Other users may couple a personal computer or home gateway device with network 120 and use that as the connection point for other devices. For example, user 140 has coupled a computer 143 between digital set-top box 141 and network 120. Alternatively, end user 150 has coupled a plurality of digital set-top boxes (e.g., digital set-top boxes 151 and 153 with network 120 and coupled each of the digital set-top boxes with a television (e.g., televisions 152 and 154 respectively). In another embodiment, a single digital set-top box may be coupled with a plurality of televisions. For example, digital set-top box 161 is coupled with televisions 162 and 163. It is appreciated that embodiments of the present invention are well suited to be utilized in configurations other than those shown in FIG. 1 as well.

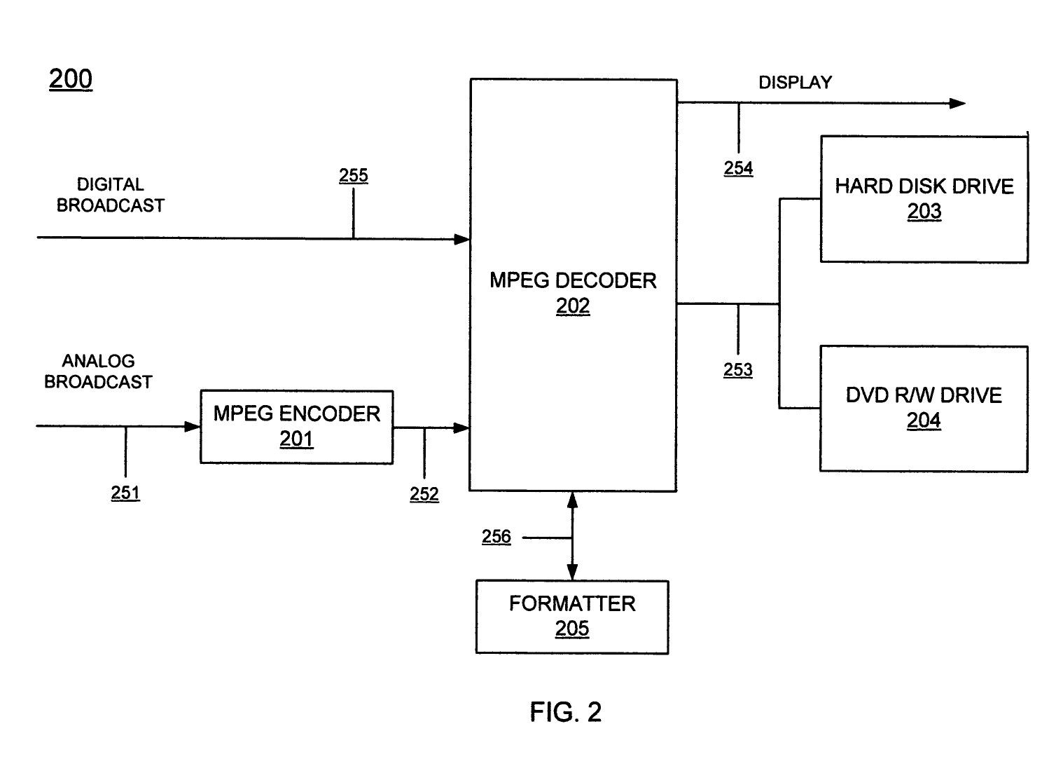

FIG. 2 is a block diagram of an exemplary system 200 for accessing restricted media content in accordance with embodiments of the present invention. In embodiments of the present invention, system 200 may be implemented as a digital set-top box or any electronic unit as discussed above with reference to FIG. 1 (e.g., digital set-top boxes 131, 141, 151, 153, and 161). In FIG. 2, analog broadcast content (e.g., media content 102 of FIG. 1) is received via coupling 251 into MPEG encoder 201. MPEG encoder 201 converts the analog signal of media content 102 into a digital format in which the data is packetized and sent to MPEG decoder 202 via coupling 252. In one embodiment, MPEG decoder 202 passes through the digital packets in encoded format to hard disk drive 203 via coupling 253 where a digital copy of media content 102 is stored. While the present embodiment teaches storing media content 102 on a hard disk drive, embodiments of the present invention are well suited for storing the a digital copy of media content 102 upon a variety of storage media. For example, a digital copy can be stored in a networked storage medium such as a storage area network (SAN) or upon another device communicatively coupled with system 200 (e.g., computer 143 of FIG. 1). In another embodiment, a digital copy of media content 102 may be maintained in repository 101 of content provider 110.

Embodiments of the present invention use hard drive 203 as temporary storage during real-time viewing to support digital video recorder features such as pause, cue, rewind, etc. For example, to pause the recorder, hard drive 203 continuously spools the data until playback of the media content is resumed. Additionally, storing a digital copy of media content 102 on hard disk drive 203 allows a user to view media content 102 at a later time that is more convenient to the user.

In embodiments of the present invention, when a user wants to access media content 102, hard disk drive 203 is accessed by MPEG decoder 202 wherein the digitally encoded content is decoded and sent via coupling 254 to a display device (e.g., a television). Again, this may be performed in a real-time operation which is substantially concurrent with the receiving of media content 102, or may occur at a later time.

In embodiments of the present invention, media content 102 may also be sent from MPEG decoder 202 to formatter 205 via coupling 256 wherein the broadcast content is converted into a format compatible with a second storage medium. For example, in one embodiment, the broadcast content is converted into a data stream format which facilitates storing media content 102 on a recordable DVD R/W disk. Again, while the present embodiment recites a recordable DVD R/W disk, embodiments of the present invention are well suited for converting media content 102 into a variety of formats. Additionally, formatter 205 may convert media content 102 into more than one format to be compatible with a variety of storage media. In embodiments of the present invention, media content 102 is converted by formatter 205 concurrent with its being displayed by a display device. In embodiments of the present invention, this may occur in real-time as media content 102 is received by system 200 (e.g., via coupling 251). Alternatively, media content 102 may be stored on hard disk drive 203 as the first digital copy and undergo the format conversion by formatter 205 at a later time. In embodiments of the present invention, this is controlled by the user of system 200. For example, a user may first wish to review media content 102 before deciding whether to create the second digital copy, and thus use more storage space of hard disk drive 203.

Additionally, system 200 can also receive a digital broadcast comprising media content 102 via coupling 255 and MPEG decoder 202. In embodiments of the present invention, the digital broadcast may comprise a standard definition (SD) digital broadcast or a high definition (HD) digital broadcast. Typically, digital broadcast content is received as a packetized data stream. The packetized data is passed through MPEG decoder 202 to hard disk drive 203 via coupling 253 wherein a digital copy of media content 102 is stored to support features of the digital video recorder as described above. The broadcast digital data is stored in an encoded MPEG format. When a user wants to access media content 102, hard disk drive 203 is accessed by MPEG decoder 202 via coupling 253 wherein it is decoded and sent to the display device via coupling 254.

As described above, in embodiments of the present invention, media content 102 may also sent to MPEG decoder 202 for decoding and then to formatter 205 via coupling 256 wherein the broadcast content is converted into a format compatible with a second storage medium (e.g., a data stream format). In embodiments of the present invention, the broadcast content is converted by formatter 205 in real-time (e.g., concurrent with its being displayed), or may be stored on hard disk drive 203 and undergo the format conversion by formatter 205 at a later time. The broadcast content undergoes format conversion and is sent through MPEG decoder 202 via coupling 256 and then to hard disk drive 203 wherein a second digital copy of the broadcast content is stored.

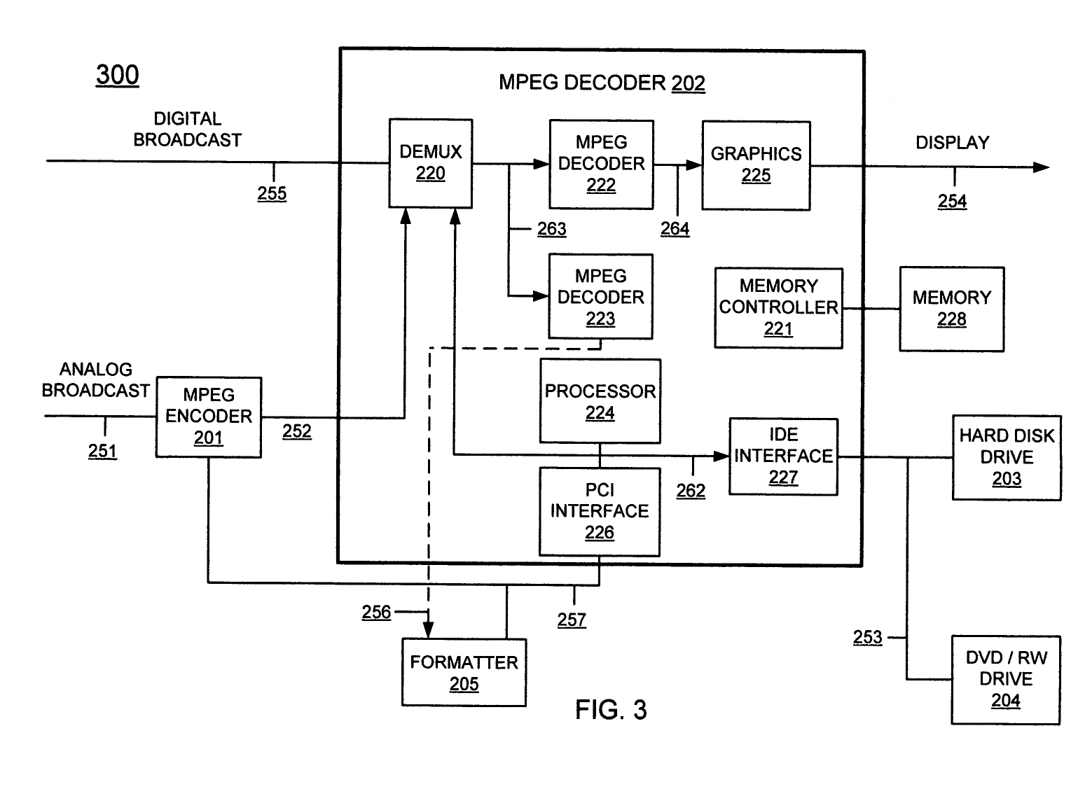

FIG. 3 is a block diagram, showing in greater detail, components of an exemplary MPEG decoder 202 in accordance with embodiments of the present invention. In embodiments of the present invention, MPEG decoder 202 may receive broadcast content that is sent via cable, terrestrial (e.g., radio broadcast), or satellite networks. In the embodiment of FIG. 3, an analog signal conveying media content 102 is received via coupling 251, digitized and encoded to a digital format by MPEG encoder 201 and sent to MPEG decoder 202 via coupling 252. Processor 224 of MPEG decoder 202 controls demux 220 to send recording data to memory 228 via memory controller 221. For clarity, the connections between memory controller 221 and other components of MPEG decoder 202 have been omitted. Processor 224 also controls memory controller to send the packetized data to an IDE interface 227 via bus 262. The packetized data is then sent via coupling 253 to hard disk drive 203 wherein a first digital copy of the encoded MPEG data is stored. If media content 102 is conveyed via a digital signal, it is sent to hard disk drive 203 wherein a digital copy of media content 102 is stored. In embodiments of the present invention, the digital copy of media content 102 may be formatted in a high definition or standard definition format.

In one embodiment, when the media content 102 is accessed for playback, hard disk drive 203 is accessed by MPEG decoder 202 via IDE interface 227 and media content 102 is sent to memory 228 via memory controller 221 and then sent to MPEG decoder 222. In embodiments of the present invention, DVR/PVR controller software processed by processor 224 typically comprises logic for controlling the presentation of the media content 102 by controlling demux 220. For example, a DVR/PVR software controller comprises logic for controlling functions such as playback, pause, cue, rewind, slow-motion play, etc. A PVR/DVR software controller comprises logic for performing the functions of a DVR controller and additional features such as tracking program preferences, recommending programs, etc. In the embodiment of FIG. 3, media content 102 is decoded by MPEG decoder 222 and sent via coupling 264 to a graphics component 225 and then to the display device via coupling 254. In embodiments of the present invention, this process can be performed in real-time, that is, substantially concurrent to receiving the broadcast content. Alternatively, media content 102 can be stored on hard disk drive 203 and accessed for playback at a later time.

In embodiments of the present invention, demux 220 sends the broadcast content to MPEG decoder 223 wherein the broadcast content may be formatted into an interim signal. For example, if the digital broadcast content comprises a high definition digital broadcast, it cannot be stored by a DVD R/W. Therefore, MPEG decoder 223 would first “down decode” the HD broadcast content into a standard definition digital format. In one embodiment, the interim signal from MPEG decoder 223 comprises an analog signal. The interim signal is sent from MPEG decoder 223 to formatter 205 via coupling 256.

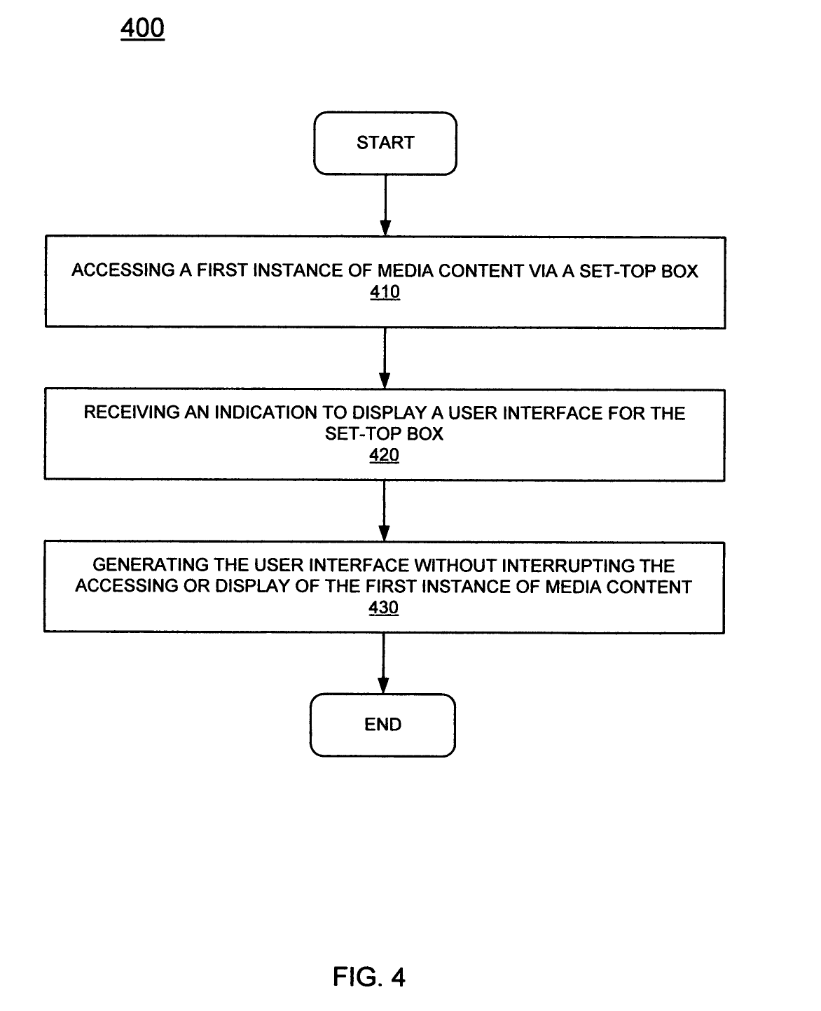

FIG. 4 is a flowchart of a method 400 of selecting an instance of recorded content in accordance with embodiments of the present invention. In step 410 of FIG. 4, a first instance of media content is accessed via a set-top box. In embodiments of the present invention, a user (e.g., end user 130 of FIG. 1) can access a first instance of media content via set-top box 131). Examples of media content which may be accessed via set-top box 131 include, but are not limited to, audio programming, video programming, text, and pictures. Typically, the user can access an instance of media content using a user interface that is generated by set-top box 131 (e.g., using graphics component 225 of FIG. 3). The user can select media content that is stored on set-top box 131 itself (e.g., on hard disk drive 203), or remotely stored (e.g., on repository 101 of FIG. 1). For instance, at step 410, the user may select a television program to watch, e.g., broadcast or recorded content can be viewed.

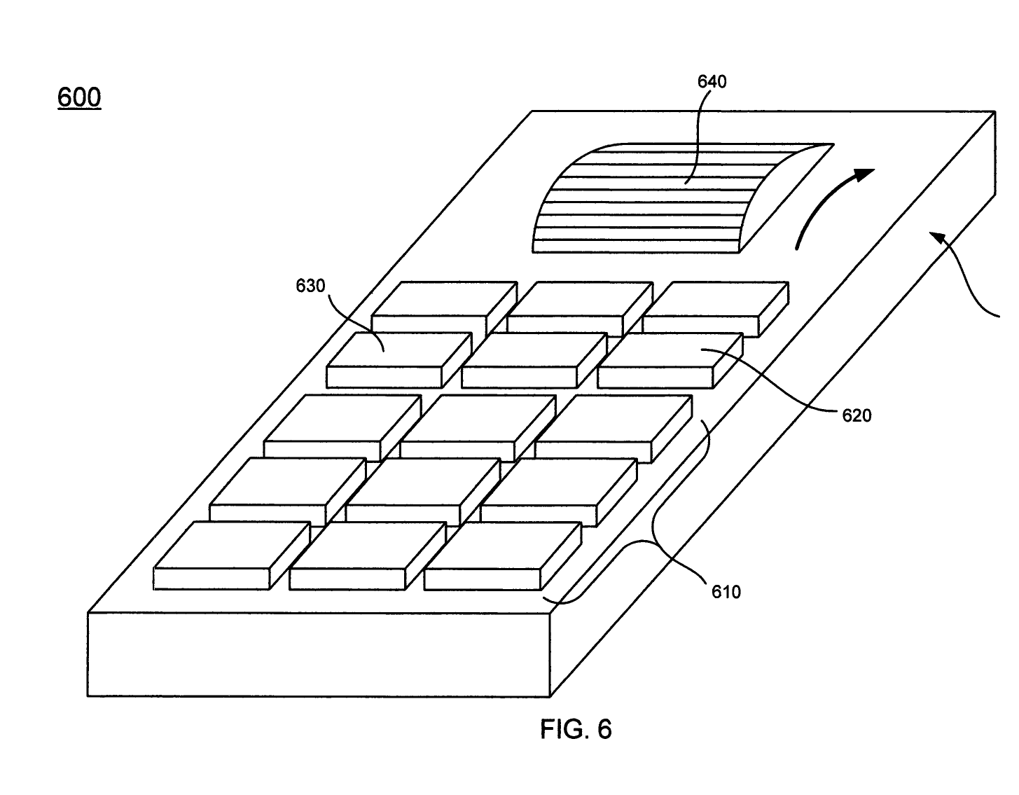

In step 420 of FIG. 4, an indication to display a user interface of the set-top box is received. In embodiments of the present invention, the user typically uses a wireless remote controller (e.g., controller 600 of FIG. 6) to control various functions performed by set-top box 131. In embodiments of the present invention, the user uses controller 600 to indicate to set-top box 131 that the user wants the user interface to be displayed. Controller 600 sends a signal which conveys to set-top box 131 a command to generate the user interface. In embodiments of the present invention, the signal is conveyed using a wireless (e.g., infrared or radio broadcast) signal. However, embodiments of the present invention are well suited to utilize a wired connection between controller 600 and set-top box 131 as well. In embodiments of the present invention, set-top box 131 “listens” for input from controller 600. In another embodiment, set-top box 131 may actively poll other devices, such as controller 600, periodically to determine if a user wants a user interface to be displayed.

In step 430 of FIG. 4, the user interface is generated without interrupting the accessing or viewing of the first instance of media content. In embodiments of the present invention, a pop-up window is generated by set-top box 131 (e.g., by graphics component 225 of FIG. 3) and which is displayed in a sub-region of display device (e.g., television 132 of FIG. 1) communicatively coupled with set-top box 131. In one embodiment, a corner of the screen can be used to display the pop-up. A scrollable listing of content may be displayed in the pop-up window.

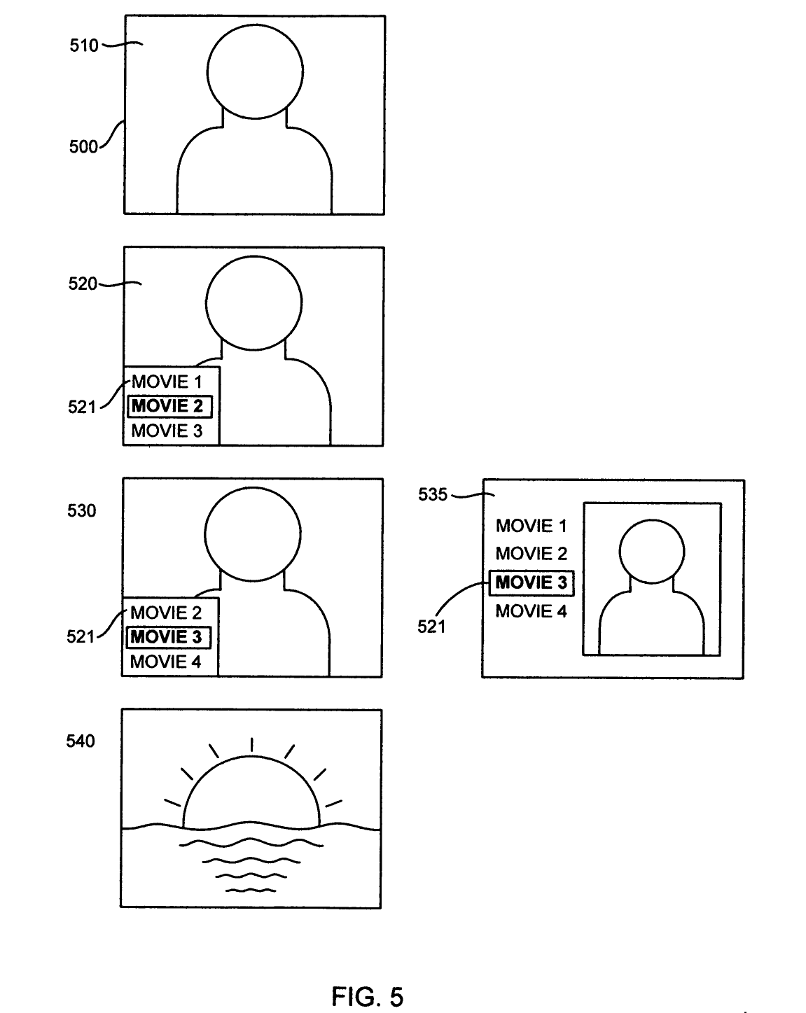

FIG. 5 illustrates exemplary screens shown on a display 500 in accordance with embodiments of the present invention. Screen 510 shows the first instance of media content displayed on display 500 (e.g., on television 132 of FIG. 1) as described above with reference to FIG. 4. In one example, this is a television program.

Screen 520 shows a user interface 521 displayed in the lower left corner of a display 500 in response to an indication to display a user interface. It is appreciated that the location of user interface 521 shown in FIG. 5 is exemplary and that user interface 521 may be displayed in a different sub-region (e.g., lower right corner) of display 500 and the location may be user selectable. In screen 520, a list of titles is displayed of media content which is accessible via set-top box 131. In embodiments of the present invention, the media content titles are associated with instances of media content which may be stored on set-top box 131 itself (e.g., stored on hard disk drive 203 of FIG. 3) or stored remotely (e.g., in repository 101 of FIG. 1).

In embodiments of the present invention, user interface 521 is a scrollable list. In other words, in response to a user input, the titles displayed in user interface 521 can scroll up or down to display additional titles. In the embodiment of FIG. 5 a title displayed in user interface 521 is highlighted. For example, in screen 520, the title “Movie 2” is displayed in bold letters and surrounded by a box to distinguish it from other titles displayed. While the present embodiment shows highlighting a title as described above, embodiments of the present invention may use other methods to distinguish a given title from other titles in user interface 521. For example, an arrow or cursor may be displayed adjacent to a given title, or user interface 521 may only display one title at a time to distinguish a given title over other titles of media content accessible via set-top box 131. It is appreciated that while user interface 521 is displayed, the first instance of media content continues to be displayed on display 500 as well. As a result, embodiments of the present invention do not interrupt the viewing of currently accessed media content while user interface 521 is displayed.

Screen 530 shows user interface 521 after a user has scrolled down to highlight a new title (e.g., “Movie 3”). At this point, the user has the option to continue to scroll through the list of titles displayed on user interface 521, or to select the highlighted title. For the purposes of the present discussion, it is assumed that the use selects the title displayed in screen 530.

Screen 540 shows that, in response to selecting “Movie 3,” the instance of media content associated with that title is now automatically accessed and displayed. Thus, display of the first instance of media content is paused until that title is selected again, or “Movie 3” finishes playing. In one embodiment, when an instance of media content is selected via user interface 521, playback of the first instance of media content is stopped. If the instance of media content accessed in step 410 is a recorded program, the current location of the media content is recorded to facilitate future access at the point where the media content was stopped. As shown in screen 540, when the new instance of media content is accessed, user interface 521 is automatically removed from the screen.

Screen 535 shows an exemplary screen displayed in accordance with an another embodiment of the present invention. In the embodiment of exemplary screen 535, user interface 521 is displayed on screen 535 while a picture-in-picture (PIP) 536 continues to display the first instance of media content accessed in step 410 of FIG. 4. In embodiments of the present invention, PIP 536 facilitates displaying media content which is currently being accessed while user interface 521 is being utilized.

FIG. 6 shows an exemplary remote controller 600 used in accordance with embodiments of the present invention. In FIG. 6, a plurality of buttons 610 are used for input functions typically found in a television and/or video recorder controller (e.g., channel selection, rewind, fast forward, pause, play, stop, record, etc.). Other buttons which may be included with controller 600 include a select button 620 for indicating the selection of an option displayed upon a television (e.g., to select a title displayed in user interface ). Resume button 630 is provided to, for example, terminate displaying user interface 521 if a user decides to not select any of the titles displayed.

Also shown in FIG. 6 is a jog-dial 640 which can, for example, be used to control a cursor, or to fast forward or rewind a recorded instance of media content. In embodiments of the present invention, jog-dial 640 is used to control the user interface 521 to select an instance of media content as discussed above with reference to FIG. 4. For example, when a user rotates jog-dial 640 in the direction represented by arrow 660, the list of titles displayed in user interface 521 scrolls upward. Similarly, if the user rotates jog-dial 640 in the other direction, the list of titles displayed in user interface 521 scrolls downward. In embodiments of the present invention, the user scrolls through the list of titles displayed in user interface 521 until a desired title is displayed and/or highlighted. In one embodiment, the user can press down on jog-dial 640 (e.g., as a push button) to select the title displayed in user interface. In another embodiment, the user can press button 620 to select the title displayed in user interface.

While the present embodiment shows a jog-dial, embodiments of the present invention may utilize a variety of user input devices such as a joystick, a trackball, cursor control buttons, etc. In embodiments of the present invention, controller 600 is wirelessly coupled with set-top box 200 via an infrared or radio component (not shown). Furthermore, in embodiments of the present invention, jog-dial 640 may be disposed on the side of controller 600 (e.g., on side 650) rather than on top.

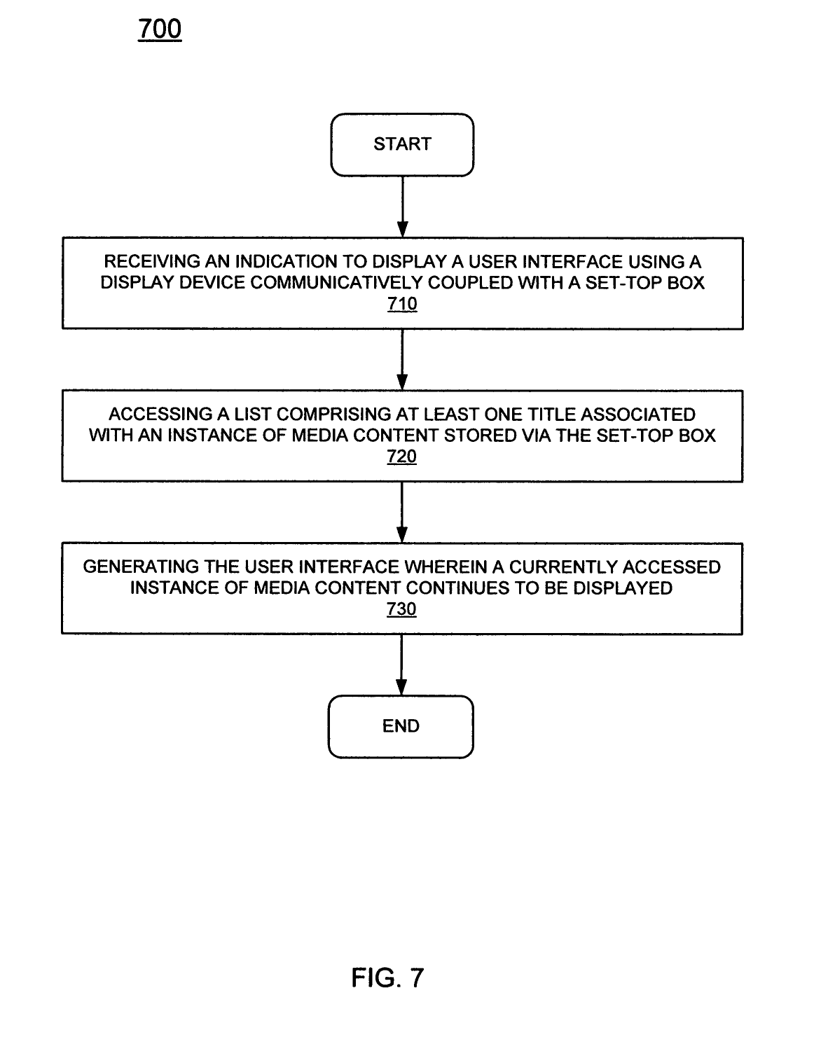

FIG. 7 is a flowchart of a method 700 for selecting media content in accordance with embodiments of the present invention. In step 710 of FIG. 7, an indication is received to display a user interface using a display device communicatively coupled with a set-top box. As described above with reference to FIG. 4, set-top box 131 “listens” for a signal from controller 600 conveying an indication to display user interface 521 on a display device (e.g., television 132 of FIG. 1) communicatively coupled with set-top box 131. The indication may be sent in response to a pre-determined button being pressed on the remote controller 600.

In step 720 of FIG. 7, a list comprising at least one title associated with an instance of media content stored via the set-top box is accessed. In embodiments of the present invention, upon receiving an indication to display user interface 521, set-top box 131 determines which instances of media content are accessible. For example, set-top box 131 may compile a list of media content that is stored in hard disk drive 203. Additionally, set-top box 131 may receive a message from content provider 110 which comprises a list of media content that are accessible to set-top box 131. Set-top box 131 then creates a list of titles of the media content which are accessible.

In step 730 of FIG. 7, the user interface is generated wherein a currently accessed instance of media content continues to be displayed. In embodiments of the present invention, graphics component 225 generates user interface 521 in a sub-region of display 500. In embodiments of the present invention, user interface 521 comprises at least one title associated with an instance of media content that is accessible via set-top box 131. Additionally, user interface 521 may display the list of titles as a scrollable list in embodiments of the present invention. In an embodiment of the present invention, in response to receiving a selection event from controller 600, set-top box 131 initiates accessing the instance of media content associated with the title highlighted in user interface 521. Additionally, when playback or accessing of the selected media content begins, a command is automatically generated (e.g., by processor 224 of FIG. 2) which terminates generating user interface 521.

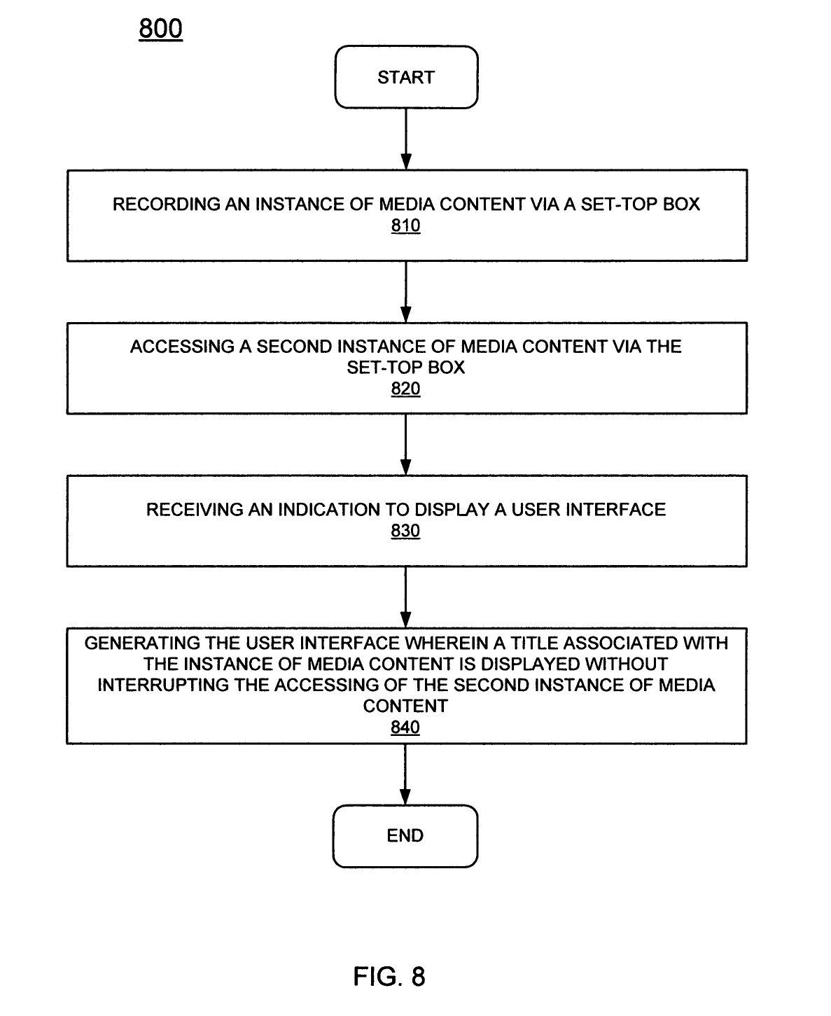

FIG. 8 is a flow chart of a method 800 for accessing media content in accordance with embodiments of the present invention. In step 810 of FIG. 8, an instance of media content is recorded via a set-top box. In embodiments of the present invention, a user can indicate to set-top box 131 to record an instance of media content. In embodiments of the present invention, the media content can be stored on hard disk drive 203.

In step 820 of FIG. 8, a second instance of media content is accessed via the set-top box. A set-top box is typically used as a portal to connect a user's household (e.g., end user 130 of FIG. 1) with sources of media content (e.g., content provider 110 of FIG. 1). This may comprise television programming, pay-per-view events, music, etc.. In embodiments of the present invention, a user accesses a second instance of media content via set-top box 131 subsequent to when step 810 has been performed.

In step 830 of FIG. 8, an indication is received to display a user interface. As described above with reference to FIG. 4, set-top box 131 listens for input from controller 600 which conveys a request to display user interface 521.

In step 840 of FIG. 8, the user interface is generated wherein a title associated with the instance of media content is displayed without interrupting the accessing of the second instance of media content. As described above with reference to FIG. 7, in embodiments of the present invention, set-top box 131 compiles a list of titles of media content which is stored upon set-top box 131. Then, using graphics component 225, set-top box 131 displays the list of titles in user interface 521. However, while displaying user interface 521, accessing the second instance of media content is not interrupted. This is advantageous over prior implementations in that the present invention allows the user to continue viewing their media content while interacting with user interface 521. Additionally, embodiments of the present invention provide a user interface which is simpler to access, therefore making presentation and selection of media content titles faster than prior implementations.

The preferred embodiment of the present invention, a method for an instant pop-up interface for a set-top box, is thus described. While the present invention has been described in particular embodiments, it should be appreciated that the present invention should not be construed as limited by such embodiments, but rather construed according to the following claims.

What is claimed is:

1. A method for an instant pop-up interface for a set-top box, said method comprising:
accessing a first instance of media content via said set-top box and rendering said first instance on a display screen;
receiving an indication to display a user interface of the set-top box; and
generating said user interface on said display screen, wherein said user interface is displayed without substantially interrupting the rendering of said first instance of media content.

2. The method as recited in claim 1 wherein said accessing comprises:
receiving said first instance of media content via a broadcast signal.

3. The method as recited in claim 1 wherein said receiving comprises:
receiving a command signal from a wireless remote control device communicatively coupled with said set-top box.

4. The method as recited in claim 1 wherein said generating said user interface comprises:
generating a list comprising at least one media content title accessible via said set-top box.

5. The method as recited in claim 4 wherein said generating said list comprises generating a scrollable list of media content titles accessible via said set-top box.

6. The method as recited in claim 5 wherein said scrollable list is displayed in a sub-region of said display device.

7. The method as recited in claim 5 wherein said generating said list comprises:
displaying said scrollable list using on said display device communicatively coupled with said set-top box; and
displaying said first instance of media content in a sub-region of said display device.

8. The method as recited in claim 1 further comprising:
receiving an indication of a selection event of a displayed media content title of said user interface;
initiating accessing of a recorded instance of media content associated with said displayed media content title; and
automatically generating a command for removing said user interface in response to said receiving an indication of a selection event.

9. A method for selecting media content via a set-top box, said method comprising:
receiving an indication to display a user interface using a display device communicatively coupled with said set-top box;
accessing a list comprising at least one title associated with an instance of media content stored via said set-top box; and
generating said user interface on said display device wherein a currently displayed instance of media continues to be displayed in conjunction with said user interface.

10. The method as recited in claim 9 wherein said generating further comprises:
displaying said user interface in a sub-region of said display device

11. The method as recited in claim 10 wherein said user interface comprises pop-up window containing a scrollable list comprising said at least one title.

12. The method as recited in claim 10 further comprising:
receiving an indication of a selection event of a media content title displayed in said user interface;
initiating the accessing of a recorded instance of media content associated with a selected content title; and
automatically generating a command for removing said user interface in response to said receiving an indication of a selection event.

13. The method as recited in claim 9 wherein said receiving said indication comprises:
receiving a wireless communication from a remote control device conveying said indication.

14. A method for accessing media content, said method comprising:
recording a first instance of media content for subsequent playback via a set-top box;
playing a second instance of media content on a display device via said set-top box;
receiving an indication to display a user interface; and
generating said user interface on said display device wherein a title associated with said first instance of media content is displayed within said user interface without interrupting the accessing of said second instance of media content.

15. The method as recited in claim 14 wherein said receiving comprises receiving a wireless indication to display said user interface.

16. The method as recited in claim 14 wherein said user interface comprises a pop-up window displayed in a sub-region of said display device.

17. The method as recited in claim 16 wherein said user interface further comprises a scrollable list comprising said title.

18. The method as recited in claim 16 further comprising:
receiving an indication of a selection event of said title.

19. The method as recited in claim 18 further comprising:
initiating accessing of said first instance of media content via said set-top box;
suspending the display of said second instance of media content; and
displaying said first instance of media content on a display device.

20. The method as recited in claim 18 further comprising:
terminating the display of said user interface in response to said selection.
